(19) United States
(12) Patent Application Publication
(10) Pub. No.: US 2015/0332596 A1
(43) Pub. Date: Nov. 19, 2015

(54) INTEGRATED LEARNING SYSTEM

(71) Applicant: JONES INTERNATIONAL. LTD., CENTENNIAL, CO (US)

(72) Inventor: WAYNE APPLEHANS, PARKER, CO (US)

(73) Assignee: JONES INTERNATIONAL, LTD., CENTENNIAL, CO (US)

(21) Appl. No.: 14/711,832

(22) Filed: May 14, 2015

Related U.S. Application Data
(60) Provisional application No. 61/993,663, filed on May 15, 2014.

(51) Int. Cl. G09B 7/00

(52) U.S. Cl. CPC G09B 7/00

(57) ABSTRACT

Embodiments of the invention provide systems and methods for delivering educational content and services. According to one embodiment, delivering educational content and services can comprise storing a plurality of content objects, each comprising a discrete piece of educational content. A definition of one or more educational elements can be received. One or more of the content objects can be assembled into the educational element based on the received definition. Once the educational element has been defined, a request for at least one of the content objects of the educational element can be received from a user and the requested content object can be retrieved and delivered to the user in response to the request. Progress of the user can be tracked against the assembled educational element based on delivery of the retrieved content object.

### CROSS-REFERENCES TO RELATED APPLICATIONS

The present application claims benefit under 35 USC 119(e) of U.S. Provisional Application No. 61/993,663, filed on May 15, 2014, by Applehans and entitled, “Integrated Learning System,” of which the entire disclosure is incorporated herein by reference for all purposes.

### BACKGROUND OF THE INVENTION

Embodiments of the present invention relate generally to methods and systems for delivering educational content and services and more particularly to an integrated learning system for storing, dynamically assembling, and delivering educational content objects.

Online content, i.e., content available to a user over the Internet or other network, can be stored and available through a variety of methods and different locations. In some cases, information may be organized into, stored in, and/or available through an online library or similar repository. Generally speaking, an online library can be considered a collection of content or references, e.g., links, to content of interest to a particular user or group of users. The content of such a library is typically accessible by the users through a browser or other client-side application executing on the user's computer or other device.

Current online libraries store content in the form of individual documents. These documents may be arranged into a folder system for organization purposes. In an educational setting, these folders or files may be organized to represent a particular course. However, these organizations are static and not easily re-organized as a particular need develops or as the content changes. In other words, these approaches are rather inflexible and require significant manual intervention to re-organize Hence, there is a need for improved methods and systems for delivering educational content and services.

### BRIEF SUMMARY OF THE INVENTION

Embodiments of the invention provide systems and methods for delivering educational content and services. According to one embodiment, delivering educational content and services can comprise storing a plurality of content objects. Each content object may comprise a discrete piece of educational content. For example, the content objects can comprise one or more of documents, videos, audio files, and/or other types of content. A definition of one or more educational elements can be received. Each educational element can comprise one or more of the content objects. The one or more of the content objects can be assembled into the educational element based on the received definition. For example, the content objects can comprise a task within the educational element, the educational element can comprise a module, and one or more tasks can be assembled to form the module. Further, the educational element can comprise a lesson and one or more modules can be assembled to form the lesson. Further still, the educational element can comprise a course and one or more lessons can be assembled to form the course.

Once the educational element has been defined, a request for at least one of the content objects of the educational element can be received from a user and the requested content object can be retrieved and delivered to the user in response to the request. In some cases, retrieving the requested content object and delivering the requested content object can comprise retrieving and delivering a plurality of content objects within a module, lesson, or course. Additionally or alternatively, retrieving the requested content object and delivering the requested content object can comprise retrieving and delivering a plurality of content objects within a module, lesson, or course. Progress of the user can be tracked against the assembled educational element based on delivery of the retrieved content object. For example, tracking progress of the user can comprise determining completion of a task, a module, a lesson, and/or a course.

### BRIEF DESCRIPTION OF THE DRAWINGS

FIG. 1 is a block diagram illustrating components of an exemplary distributed system in which various embodiments of the present invention may be implemented.

FIG. 2 is a block diagram illustrating components of a system environment by which services provided by embodiments of the present invention may be offered as cloud services.

FIG. 3 is a block diagram illustrating an exemplary computer system in which embodiments of the present invention may be implemented.

FIG. 4 is a block diagram illustrating, at a high-level, functional components of a system for implementing an integrated learning system architecture according to one embodiment of the present invention.

FIG. 5 is a block diagram conceptually illustrating use of an integrated learning system to deliver educational content and services according to one embodiment of the present invention

FIG. 6 is a flowchart illustrating a process for delivering educational content and services according to one embodiment of the present invention.

FIG. 7 illustrates an exemplary user interface for representing tracked progress according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

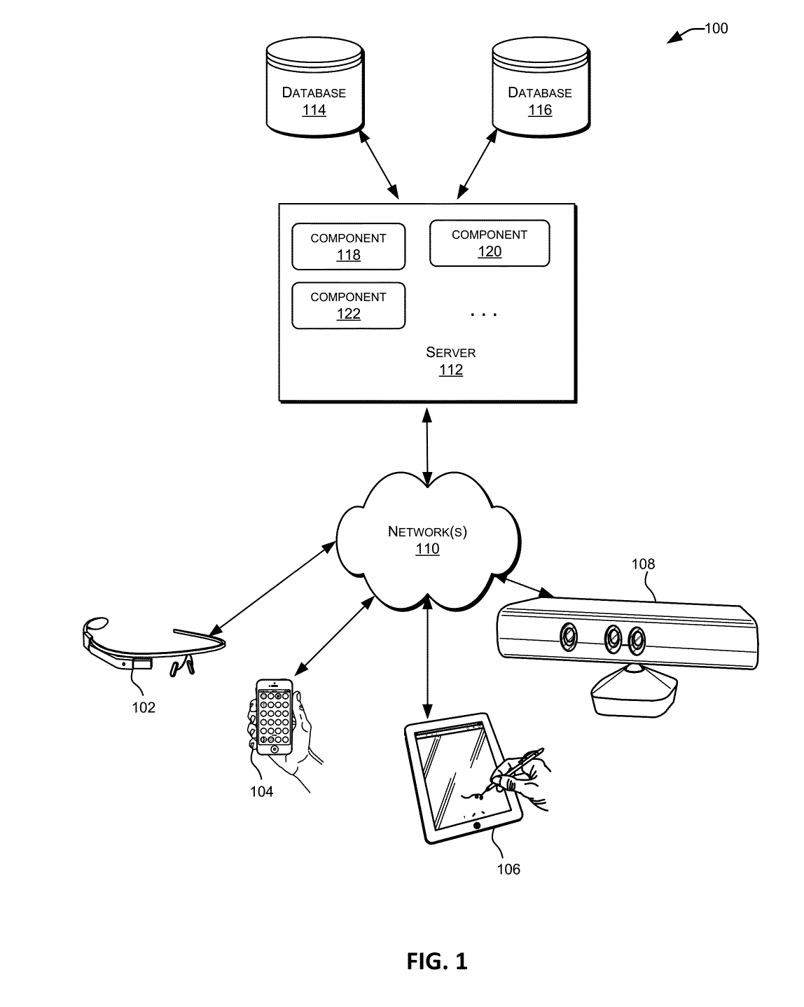

FIG. 1 is a block diagram illustrating components of an exemplary distributed system in which various embodiments of the present invention may be implemented. In the illustrated embodiment, distributed system 100 includes one or more client computing devices 102, 104, 106, and 108, which are configured to execute and operate a client application such as a web browser, proprietary client (e.g., Oracle Forms), or the like over one or more network(s) 110. Server 112 may be communicatively coupled with remote client computing devices 102, 104, 106, and 108 via network 110.

In various embodiments, server 112 may be adapted to run one or more services or software applications provided by one or more of the components of the system. In some embodiments, these services may be offered as web-based or cloud services or under a Software as a Service (SaaS) model to the users of client computing devices 102, 104, 106, and/or 108. Users operating client computing devices 102, 104, 106, and/or 108 may in turn utilize one or more client applications to interact with server 112 to utilize the services provided by these components.

In the configuration depicted in the figure, the software components 118, 120 and 122 of system 100 are shown as being implemented on server 112. In other embodiments, one or more of the components of system 100 and/or the services provided by these components may also be implemented by one or more of the client computing devices 102, 104, 106, and/or 108. Users operating the client computing devices may then utilize one or more client applications to use the services provided by these components. These components may be implemented in hardware, firmware, software, or combinations thereof. It should be appreciated that various different system configurations are possible, which may be different from distributed system 100. The embodiment shown in the figure is thus one example of a distributed system for implementing an embodiment system and is not intended to be limiting.

Client computing devices 102, 104, 106, and/or 108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 102, 104, 106, and 108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 110.

Although exemplary distributed system 100 is shown with four client computing devices, any number of client computing devices may be supported. Other devices, such as devices with sensors, etc., may interact with server 112.

Network(s) 110 in distributed system 100 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 110 can be a local area network (LAN), such as one based on Ethernet, Token-Ring and/or the like. Network(s) 110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 112 may be composed of one or more general purpose computers, specialized server computers (including, by way of example, PC (personal computer) servers, UNIXO servers, mid-range servers, mainframe computers, rack-mounted servers, etc.), server farms, server clusters, or any other appropriate arrangement and/or combination. In various embodiments, server 112 may be adapted to run one or more services or software applications described in the foregoing disclosure. For example, server 112 may correspond to a server for performing processing described above according to an embodiment of the present disclosure.

Server 112 may run an operating system including any of those discussed above, as well as any commercially available server operating system. Server 112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 112 may include one or more applications to analyze and consolidate data feeds and/or event updates received from users of client computing devices 102, 104, 106, and 108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 112 may also include one or more applications to display the data feeds and/or real-time events via one or more display devices of client computing devices 102, 104, 106, and 108.

Distributed system 100 may also include one or more databases 114 and 116. Databases 114 and 116 may reside in a variety of locations. By way of example, one or more of databases 114 and 116 may reside on a non-transitory storage medium local to (and/or resident in) server 112. Alternatively, databases 114 and 116 may be remote from server 112 and in communication with server 112 via a network-based or dedicated connection. In one set of embodiments, databases 114 and 116 may reside in a storage-area network (SAN). Similarly, any necessary files for performing the functions attributed to server 112 may be stored locally on server 112 and/or remotely, as appropriate. In one set of embodiments, databases 114 and 116 may include relational databases, such as databases provided by Oracle, that are adapted to store, update, and retrieve data in response to SQL-formatted commands.

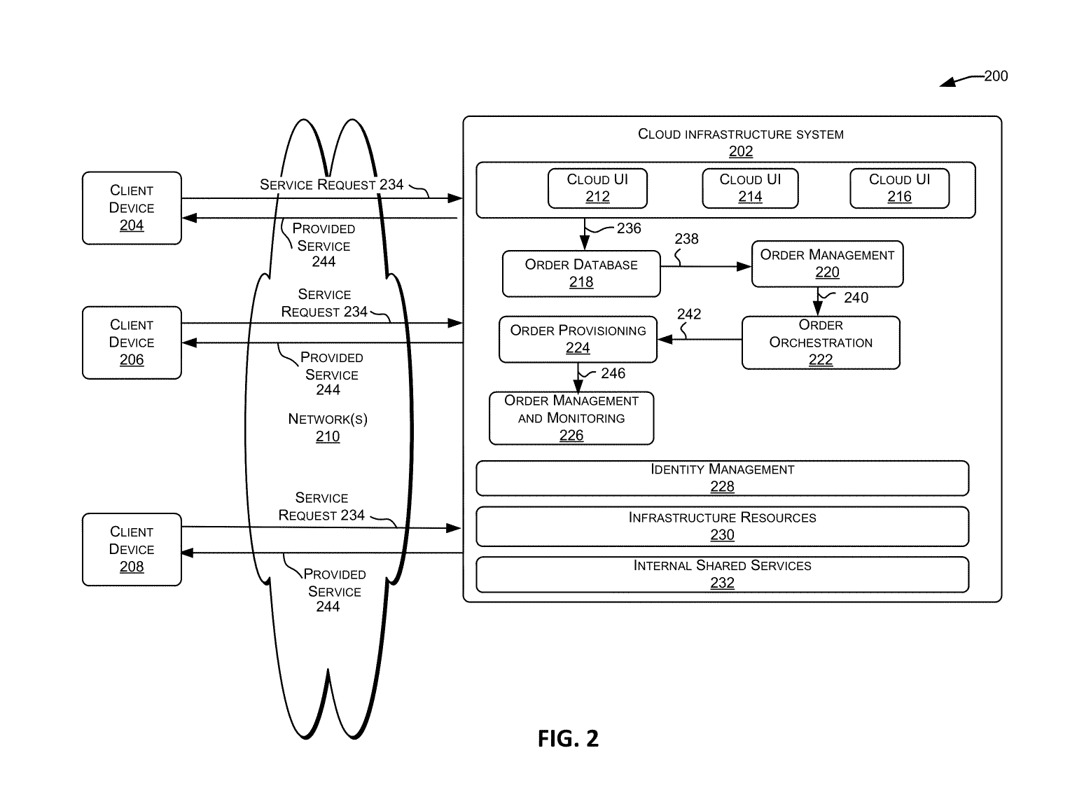

FIG. 2 is a block diagram illustrating components of a system environment by which services provided by embodiments of the present invention may be offered as cloud services. In the illustrated embodiment, system environment 200 includes one or more client computing devices 204, 206, and 208 that may be used by users to interact with a cloud infrastructure system 202 that provides cloud services. The client computing devices may be configured to operate a client application such as a web browser, a proprietary client application (e.g., Oracle Forms), or some other application, which may be used by a user of the client computing device to interact with cloud infrastructure system 202 to use services provided by cloud infrastructure system 202.

It should be appreciated that cloud infrastructure system 202 depicted in the figure may have other components than those depicted. Further, the embodiment shown in the figure is only one example of a cloud infrastructure system that may incorporate an embodiment of the invention. In some other embodiments, cloud infrastructure system 202 may have more or fewer components than shown in the figure, may combine two or more components, or may have a different configuration or arrangement of components.

Client computing devices 204, 206, and 208 may be devices similar to those described above for 102, 104, 106, and 108.

Although exemplary system environment 200 is shown with three client computing devices, any number of client computing devices may be supported. Other devices such as devices with sensors, etc. may interact with cloud infrastructure system 202.

Network(s) 210 may facilitate communications and exchange of data between clients 204, 206, and 208 and cloud infrastructure system 202. Each network may be any type of network familiar to those skilled in the art that can support data communications using any of a variety of commercially-available protocols, including those described above for network(s) 110.

Cloud infrastructure system 202 may comprise one or more computers and/or servers that may include those described above for server 112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 202 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 202 may be adapted to automatically provision, manage and track a customer's subscription to services offered by cloud infrastructure system 202. Cloud infrastructure system 202 may provide the cloud services via different deployment models. For example, services may be provided under a public cloud model in which cloud infrastructure system 202 is owned by an organization selling cloud services (e.g., owned by Oracle) and the services are made available to the general public or different industry enterprises. As another example, services may be provided under a private cloud model in which cloud infrastructure system 202 is operated solely for a single organization and may provide services for one or more entities within the organization. The cloud services may also be provided under a community cloud model in which cloud infrastructure system 202 and the services provided by cloud infrastructure system 202 are shared by several organizations in a related community. The cloud services may also be provided under a hybrid cloud model, which is a combination of two or more different models.

In some embodiments, the services provided by cloud infrastructure system 202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 202. Cloud infrastructure system 202 then performs processing to provide the services in the customer's subscription order.

In some embodiments, the services provided by cloud infrastructure system 202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 202 may also include infrastructure resources 230 for providing the resources used to provide various services to customers of the cloud infrastructure system. In one embodiment, infrastructure resources 230 may include pre-integrated and optimized combinations of hardware, such as servers, storage, and networking resources to execute the services provided by the PaaS platform and the SaaS platform.

In some embodiments, resources in cloud infrastructure system 202 may be shared by multiple users and dynamically re-allocated per demand. Additionally, resources may be allocated to users in different time zones. For example, cloud infrastructure system 230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 232 may be provided that are shared by different components or modules of cloud infrastructure system 202 and by the services provided by cloud infrastructure system 202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 202, and the like.

In one embodiment, as depicted in the figure, cloud management functionality may be provided by one or more modules, such as an order management module 220, an order orchestration module 222, an order provisioning module 224, an order management and monitoring module 226, and an identity management module 228. These modules may include or be provided using one or more computers and/or servers, which may be general purpose computers, specialized server computers, server farms, server clusters, or any other appropriate arrangement and/or combination.

In exemplary operation 234, a customer using a client device, such as client device 204, 206 or 208, may interact with cloud infrastructure system 202 by requesting one or more services provided by cloud infrastructure system 202 and placing an order for a subscription for one or more services offered by cloud infrastructure system 202. In certain embodiments, the customer may access a cloud User Interface (UI), cloud UI 212, cloud UI 214 and/or cloud UI 216 and place a subscription order via these UIs. The order information received by cloud infrastructure system 202 in response to the customer placing an order may include information identifying the customer and one or more services offered by the cloud infrastructure system 202 that the customer intends to subscribe to.

After an order has been placed by the customer, the order information is received via the cloud UIs, 212, 214 and/or 216.

At operation 236, the order is stored in order database 218. Order database 218 can be one of several databases operated by cloud infrastructure system 218 and operated in conjunction with other system elements.

At operation 238, the order information is forwarded to an order management module 220. In some instances, order management module 220 may be configured to perform billing and accounting functions related to the order, such as verifying the order, and upon verification, booking the order.

At operation 240, information regarding the order is communicated to an order orchestration module 222. Order orchestration module 222 may utilize the order information to orchestrate the provisioning of services and resources for the order placed by the customer. In some instances, order orchestration module 222 may orchestrate the provisioning of resources to support the subscribed services using the services of order provisioning module 224.

In certain embodiments, order orchestration module 222 enables the management of business processes associated with each order and applies business logic to determine whether an order should proceed to provisioning. At operation 242, upon receiving an order for a new subscription, order orchestration module 222 sends a request to order provisioning module 224 to allocate resources and configure those resources needed to fulfill the subscription order. Order provisioning module 224 enables the allocation of resources for the services ordered by the customer. Order provisioning module 224 provides a level of abstraction between the cloud services provided by cloud infrastructure system 200 and the physical implementation layer that is used to provision the resources for providing the requested services. Order orchestration module 222 may thus be isolated from implementation details, such as whether or not services and resources are actually provisioned on the fly or pre-provisioned and only allocated/assigned upon request.

At operation 244, once the services and resources are provisioned, a notification of the provided service may be sent to customers on client devices 204, 206 and/or 208 by order provisioning module 224 of cloud infrastructure system 202.

At operation 246, the customer's subscription order may be managed and tracked by an order management and monitoring module 226. In some instances, order management and monitoring module 226 may be configured to collect usage statistics for the services in the subscription order, such as the amount of storage used, the amount data transferred, the number of users, and the amount of system up time and system down time.

In certain embodiments, cloud infrastructure system 200 may include an identity management module 228. Identity management module 228 may be configured to provide identity services, such as access management and authorization services in cloud infrastructure system 200. In some embodiments, identity management module 228 may control information about customers who wish to utilize the services provided by cloud infrastructure system 202. Such information can include information that authenticates the identities of such customers and information that describes which actions those customers are authorized to perform relative to various system resources (e.g., files, directories, applications, communication ports, memory segments, etc.) Identity management module 228 may also include the management of descriptive information about each customer and about how and by whom that descriptive information can be accessed and modified.

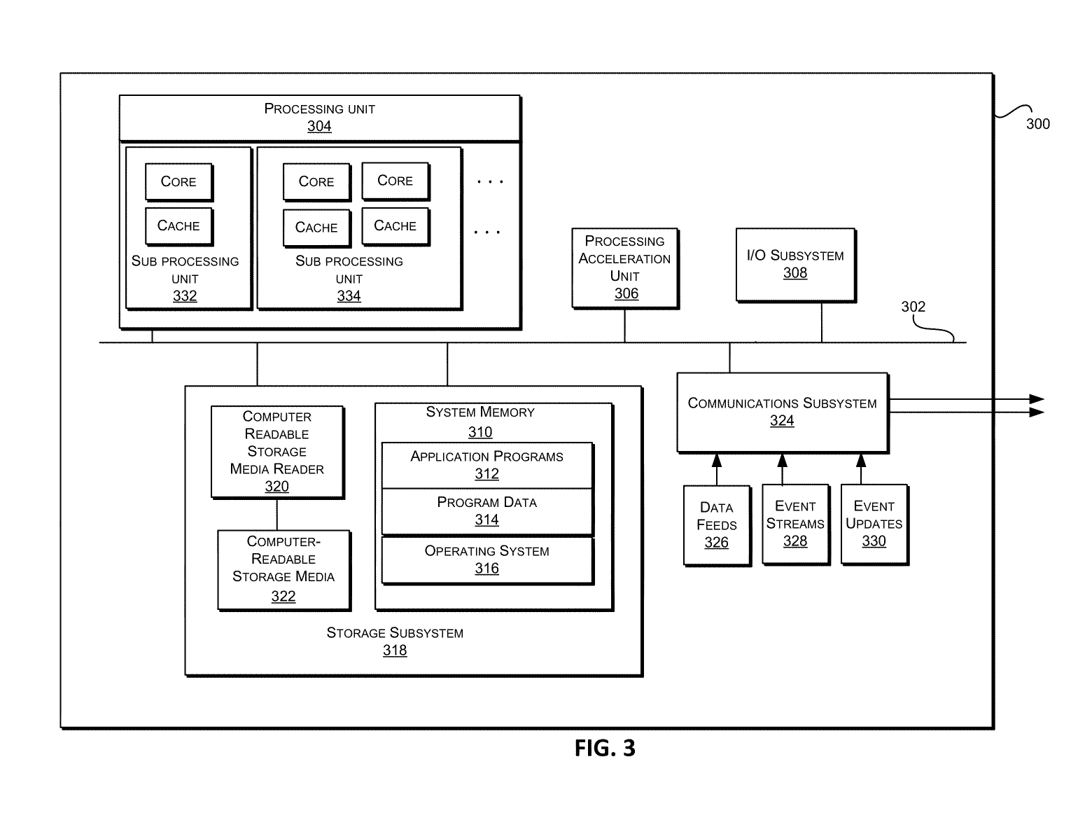

FIG. 3 is a block diagram illustrating an exemplary computer system in which embodiments of the present invention may be implemented. The system 300 may be used to implement any of the computer systems described above. As shown in the figure, computer system 300 includes a processing unit 304 that communicates with a number of peripheral subsystems via a bus subsystem 302. These peripheral subsystems may include a processing acceleration unit 306, an I/O subsystem 308, a storage subsystem 318 and a communications subsystem 324. Storage subsystem 318 includes tangible computer-readable storage media 322 and a system memory 310.

Bus subsystem 302 provides a mechanism for letting the various components and subsystems of computer system 300 communicate with each other as intended. Although bus subsystem 302 is shown schematically as a single bus, alternative embodiments of the bus subsystem may utilize multiple buses. Bus subsystem 302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 304, which can be implemented as one or more integrated circuits (e.g., a conventional microprocessor or microcontroller), controls the operation of computer system 300. One or more processors may be included in processing unit 304. These processors may include single core or multicore processors. In certain embodiments, processing unit 304 may be implemented as one or more independent processing units 332 and/or 334 with single or multicore processors included in each processing unit. In other embodiments, processing unit 304 may also be implemented as a quad-core processing unit formed by integrating two dual-core processors into a single chip.

In various embodiments, processing unit 304 can execute a variety of programs in response to program code and can maintain multiple concurrently executing programs or processes. At any given time, some or all of the program code to be executed can be resident in processor(s) 304 and/or in storage subsystem 318. Through suitable programming, processor(s) 304 can provide various functionalities described above. Computer system 300 may additionally include a processing acceleration unit 306, which can include a digital signal processor (DSP), a special-purpose processor, and/or the like.

I/O subsystem 308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 300 may comprise a storage subsystem 318 that comprises software elements, shown as being currently located within a system memory 310. System memory 310 may store program instructions that are loadable and executable on processing unit 304, as well as data generated during the execution of these programs.

Depending on the configuration and type of computer system 300, system memory 310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 304. In some implementations, system memory 310 may include multiple different types of memory, such as static random access memory (SRAM) or dynamic random access memory (DRAM). In some implementations, a basic input/output system (BIOS), containing the basic routines that help to transfer information between elements within computer system 300, such as during start-up, may typically be stored in the ROM. By way of example, and not limitation, system memory 310 also illustrates application programs 312, which may include client applications, Web browsers, mid-tier applications, relational database management systems (RDBMS), etc., program data 314, and an operating system 316. By way of example, operating system 316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 318 may also provide a tangible computer-readable storage medium for storing the basic programming and data constructs that provide the functionality of some embodiments. Software (programs, code modules, instructions) that when executed by a processor provide the functionality described above may be stored in storage subsystem 318. These software modules or instructions may be executed by processing unit 304. Storage subsystem 318 may also provide a repository for storing data used in accordance with the present invention.

Storage subsystem 300 may also include a computer-readable storage media reader 320 that can further be connected to computer-readable storage media 322. Together and, optionally, in combination with system memory 310, computer-readable storage media 322 may comprehensively represent remote, local, fixed, and/or removable storage devices plus storage media for temporarily and/or more permanently containing, storing, transmitting, and retrieving computer-readable information.

Computer-readable storage media 322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 300.

By way of example, computer-readable storage media 322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 322 may include, but is not limited to, Zip® drives, flash memory cards, universal serial bus (USB) flash drives, secure digital (SD) cards, DVD disks, digital video tape, and the like. Computer-readable storage media 322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 300.

Communications subsystem 324 provides an interface to other computer systems and networks. Communications subsystem 324 serves as an interface for receiving data from and transmitting data to other systems from computer system 300. For example, communications subsystem 324 may enable computer system 300 to connect to one or more devices via the Internet. In some embodiments communications subsystem 324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 324 can provide wired network connectivity (e.g., Ethernet) in addition to or instead of a wireless interface.

In some embodiments, communications subsystem 324 may also receive input communication in the form of structured and/or unstructured data feeds 326, event streams 328, event updates 330, and the like on behalf of one or more users who may use computer system 300.

By way of example, communications subsystem 324 may be configured to receive data feeds 326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 324 may also be configured to receive data in the form of continuous data streams, which may include event streams 328 of real-time events and/or event updates 330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 324 may also be configured to output the structured and/or unstructured data feeds 326, event streams 328, event updates 330, and the like to one or more databases that may be in communication with one or more streaming data source computers coupled to computer system 300.

Computer system 300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

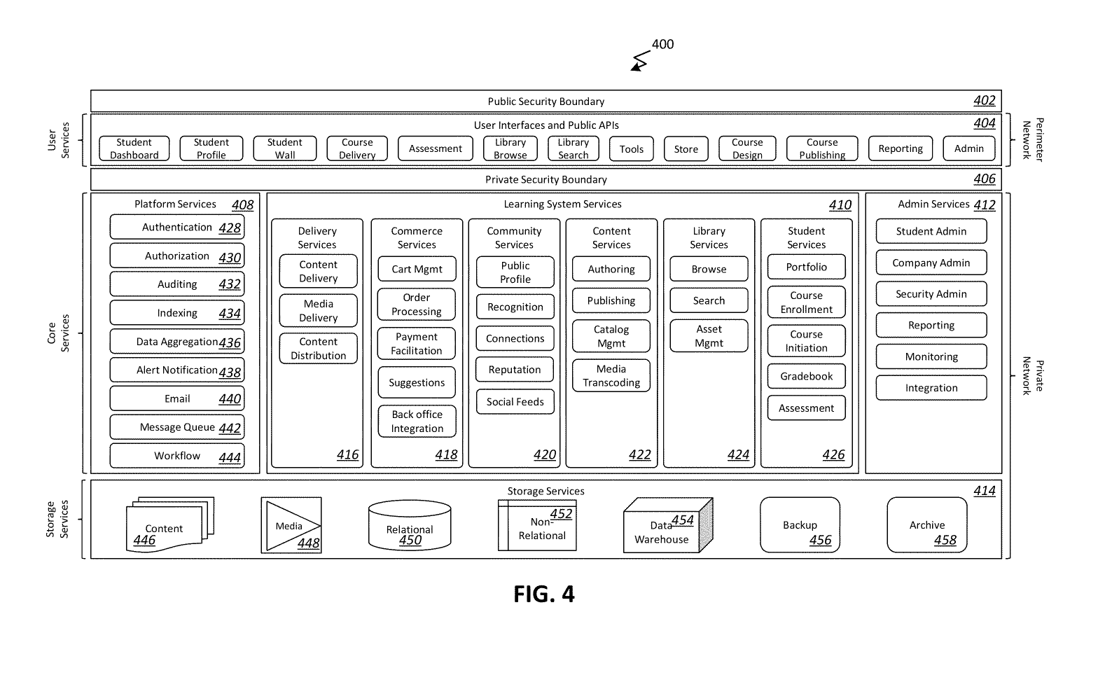

FIG. 4 is a block diagram illustrating, at a high-level, functional components of a system for implementing an integrated learning system architecture according to one embodiment of the present invention. As illustrated in this example, the integrated learning system 400 can include a public security boundary 402, perimeter network 404, and private security boundary 406. The public security boundary 402 can form a public edge of the perimeter network 404 for the integrated learning system 400 and can serve to limit the surface area and attack vectors of the system. This security boundary can be responsible for restricting access to the User Interfaces (UIs) and Application Programming Interface (API) services within the perimeter network 404 to only supported ports and accepted protocols, ensuring that communications are appropriately encrypted. This security boundary 402 can also be responsible for application-level protection, deep packet inspection, intrusion prevention, and Distributed Denial of Service (DDoS) attack protection, along with other security protections as a person skilled in the art will appreciate.

The perimeter network 404 can host the UI and API components for the Integrated Learning System 400 including but not limited to a student dashboard interface, a student profile interface, a student wall interface, a course delivery interface, an assessment interface, a library browse interface, a library search interface, a tools interface, a store interface, a course design interface, a course publishing interface, a reporting interface and/or, an administration interface. Human and programmatic interactions with the system 400 occur through this network 404 and these UI and API services, with the limited exception of trusted administrators performing system troubleshooting and maintenance operations through a set of administrative services 412 including but not limited to student administration services, company administration services, security administration services, reporting services, monitoring services, and/or integration services. Communications channels from the public network into the perimeter network 404 can be encrypted using industry standard encryption protocols.

The private security boundary 406 can form the private edge of the perimeter network 404 for the integrated learning system 400 and can be responsible for securing access to core services of a private network. Services of the private network can include but are not limited to platform services 408, learning system services 410, and storage services 414, each of which will be described in greater detail below. Generally speaking, the private security boundary 406 can comprise a defense-in-depth boundary that helps ensure that perimeter network 404 breaches do not result in unrestricted access to core services and data. The private security boundary 406 can allow inbound requests from the perimeter network 404 to access private network services if the requests use allowed ports and supported protocols.

The private network portion of the integrated learning system 400 can hosts the internal services and data stores, facilitating efficient and secure service-to-service and service-to-storage interactions. The core services in the private network do not need internal authentication boundaries, but rather, each service can be responsible for authorizing requested operations using the security claims provided with the request, whether from services in the perimeter network 404 or from other core services. Core services can include platform services 408 and learning system services 410 and can comprise private services within the integrated learning system 400 that are responsible for enabling the ongoing functional and operational aspects of the system. As private services, they can be hosted behind the secured perimeter network 404 and can have the ability to connect with one another without crossing a security boundary. However, external calls into these services can be limited to access from the perimeter network 404 and the security boundary it provides. Core services can be loosely coupled and asynchronous in nature, allowing for scale out and fault tolerance of individual service instances. Exemplary services as illustrate in FIG. 4 will be described below. However, this list of services should not be considered exclusive or complete. Rather, additional and/or different other services are contemplated and also considered to be within the scope of the present invention.

For example, delivery services 416 can be part of the learning system services 410 and can be responsible for brokering the delivery of content and media for tasks, modules, lessons, and courses. The delivery services 416 may draw upon both internal platform services 408 and storage services 414 as well as external content delivery and streaming media services to facilitate delivery. The delivery services 416 can also be responsible for selecting the right content and media formats for a given end user device as well as facilitating the distribution of media into content delivery networks.

Additionally or alternatively, commerce services 418 can be part of the learning system services 410 and can be responsible for cart management and order processing for both individual students and enterprise accounts. These services 418 also facilitate payment processing, but they can delegate acceptance, transmission, and storage of cardholder data to an external, PCI compliant payment processor. These commerce services 418 can receive from the payment processor a token that can be used for future recurring (i.e., subscription) and one-time purchases. Commerce services 418 can also communicate with accounting, order fulfillment, and other back office systems, as necessary. The commerce services 418 can be responsible for providing suggestions based on purchase history, student recommendations, and award achievement.

Community services 418 can additionally or alternatively be part of the learning system services 410 and can be responsible for facilitating interactions between students, subject matter experts, customer care professionals, training coordinators, and other community members. These services 418 can provide support for profile management for both students and companies, support for recognition of student progress toward ribbons, badges, and certificates, and the ability for community members to connect with one another to stay updated on progress. Community services 418 can also be responsible for facilitating reputation points for participants, allowing community members to gain stronger reputations by providing quality answers to community questions. These services 418 can also enable publishing of updates to external social networks.

In some cases, content services 422 can be part of the learning system services 410 and can be responsible for enabling task, module, lesson, and course authoring and publishing. These services 422 can also be responsible for enabling the creation and management of course catalogs, which identify available courses, along with course descriptions and prerequisites, as well as available awards and certificates. The content services 422 can be responsible for any media transcoding required to support different form factors and device capabilities.

Additionally or alternatively, library services 424 can be part of the learning system services 410 and can be responsible for providing browse and/or search support across the available set of tasks, modules, lessons, and courses for a given user. These services 424 can also be responsible for enabling metadata descriptions, tagging support, and management of rich content and media assets in support of both browsing and searching operations. These operations can also support the selection of content by instructional designers for inclusion in new tasks, modules, lessons, and courses.

Student services 426 can be part of the learning system services 410 and can be responsible for enabling students to prepare for and initiate/continue courses, as well as to take optional and required assessments as they progress through their coursework. These services 426 can also facilitate viewing of course progress, course grades, and overall transcript.

Platform services 408 can include but are not limited to authentication services 428, authorization services 430, auditing services 432, indexing services 434, data aggregation services 436, alert notification services 438, email services 440, message queue services 443, and/or workflow services 444. According to one embodiment, the authentication service 428 can provide verification of user credentials (perhaps in conjunction with an external federated identity manager), access tokens issuance and management, auditing of authentication requests, status reporting for authentication requests, etc. The authorization service 430 can provide, for example, access permissions given an access token, auditing of authorization requests, status reporting for authorization requests, and/or other functions. According to one embodiment, the auditing service 432 can provide functions including but not limited to receiving events from other services, selectively logging events based on system and configuration settings, status reporting for auditing operations, and the like. The indexing service 434 can provide, for example, runtime configuration of indexing rules, crawling both structured and unstructured data, constructing one or more indexes for crawled data, status reporting for indexing operations, and the like. According to one embodiment, the data aggregation service 436 can provide runtime configuration of data aggregation rules, data aggregation according to data aggregation rules, interaction with storage services for storage of aggregated data for use by other services, status reporting for aggregation operations, and/or other functions. The alert notification service 438 can provide functions including but not limited to distribution of alerts to appropriate subscribers/listeners, management of subscribers for alerts, status reporting for alerts, and the like. According to one embodiment, the email service 440 can provide distribution of emails to recipients, mail merge for email distribution, status reporting for email delivery, and/or other functions. The message queue service 442 can provide, for example, durable message queues that facilitate asynchronous communication between other services, management of subscriptions for messages, and/or status reporting of message queues. The workflow service 444 can provide functions including but not limited to durable multi-step business and system process execution, management of workflows and workflow versions, status reporting of workflow progress, and the like.

Storage services 414 can be private services within the integrated learning system 400 that are responsible for storing, querying, updating, and deleting data of various forms, including rich content, media assets, relational data, and tabular data. These services 414 can be accessible to platform services 408 and/or learning system services 410, which may need to authenticate using appropriate data store authentication. If the platform services 408 and/or learning system services 410 are hosted separately from the storage services 414, secure network protocols can be used for communication and data transmissions. Storage services 414 can also be responsible for backup and data archival operations.

More specifically, the content storage service 446 can provide storage and management of unstructured content typically in the form of user-authored documents or files, such as Word and PDF files. These services 446 can provide for encryption of data as required or requested. Additionally or alternatively, the content storage service can provide an API for content and metadata inquiries and management. The content storage service 446 can support content versioning as needed and/or can provide scale out and high availability capabilities.

According to one embodiment, the media storage service 448 can provide for storage and management of media typically in the form of image, audio, and video files and may provide encryption of the data as required or desired. The service 448 can include an API for media file and metadata inquiries and management and/or can support media file versioning. In some implementations, the media storage service 448 can additionally provide scale out and high availability capabilities.

The relational storage service 450 can provide transactional storage and management of normalized relational data. In some cases, the service 450 can also provide encryption of the data as required or desired. The relational storage service 450 can provide a query language for data selection and management and/or a data definition language for creating and managing relational schema. The service 450 can also provide relational index definition and management. In some implementations, the relational storage service 450 can additionally or alternatively provide scale out and high availability capabilities.

According to one embodiment, the non-relational storage service 452 can provide storage and management of non-relational, self-contained data structures and may, in some cases, also provide encryption of data as required or desired. The service 452 can provide an API for data structure selection and management. Functions provided by this service 452 can also include index definition and management. In some implementations, the non-relational storage service 452 can additionally or alternatively provide scale out and high availability capabilities.

The data warehouse service 454 can provide storage and management of data typically arranged as dimensions and facts to facilitate reporting and data analysis and may also provide encryption of the data as required or desired. This service 454 can provide an API for data selection and management and/or an API for data loads using Extract-Transform-Load (ETL) tools and processes. In some implementations, the data warehouse service 454 can additionally or alternatively provide scale out and high availability capabilities.

According to one embodiment, the backup service 456 can provide full, differential, and incremental backup capabilities and may provide encryption of the backup data. This service 456 can provide a management interface for definition and monitoring of backup operations and/or can provide notification capabilities for failed backup operations. In some cases, the backup service 456 can provide for consolidation of backups from other storage services. Additionally, this service can facilitate redundant backup storage.

The archive service 458 can provide for archiving data from other storage services. This service 458 can provide a management interface for definition and monitoring of archival operations. Additionally or alternatively, the archive service 458 can provide notification capabilities for failed archival operations. As noted above, this list of services should not be considered exclusive or complete. Rather, additional and/or different other functions of the services illustrated and described here. Similarly, additional and/or different other services are contemplated and also considered to be within the scope of the present invention.

Stated another way, the integrated learning system 400 can receive content objects or an indication of the content objects, e.g., pointers, links, etc., from an author of an educational element through the perimeter network 404 and using the content services 422. These content objects can be stored in a library by the storage services 414. Each content object may comprise a discrete piece of educational content. For example, the content objects can comprise one or more of documents, videos, audio files, and/or other types of content. A definition of one or more educational elements can also be received, e.g., from the author of the educational element using authoring tools of the content services 422. For example, the content objects can comprise a task within the educational element, the educational element can comprise a module, and one or more tasks are assembled to form the module. Further, the educational element can comprise a lesson and one or more modules can be assembled to form the lesson. Further still, the educational element can comprise a course and one or more lessons can be assembled to form the course.

Once the educational element has been defined, access to the content objects and educational elements can be provided by the integrated learning system 400 to a user through the perimeter network 404. For example, providing access to the content objects and educational elements to the user can comprise allowing the user to browse the content objects and educational elements using a browse tool of the library services 426. Additionally or alternatively, providing access to the content objects and educational elements to the user can comprise allowing the user to search the content objects and educational elements using search tools of the library services 424.

At some point, a request for at least one of the content objects of the educational element can be received from the user through the perimeter network 404 and the requested content object can be retrieved by the storage services 414 and delivered to the user by the delivery services 416 through the perimeter network 404 in response to the request. According to one embodiment, delivery of the requested content may depend upon the user having previously or concurrently purchased access to that content through the commerce services 418. In some cases, retrieving the requested content object and delivering the requested content object can comprise retrieving and delivering a plurality of content objects within a module, lesson, or course. Additionally or alternatively, retrieving the requested content object and delivering the requested content object can comprise retrieving and delivering a plurality of content objects within a module, lesson, or course. Progress of the user can be tracked against the assembled educational element based on delivery of the retrieved content object. For example, tracking progress of the user can comprise determining completion of a task, a module, a lesson, and/or a course. This tracked progress can be monitored by the user and/or others through the student services 426, e.g., through a dashboard interface provided by the student services 426.

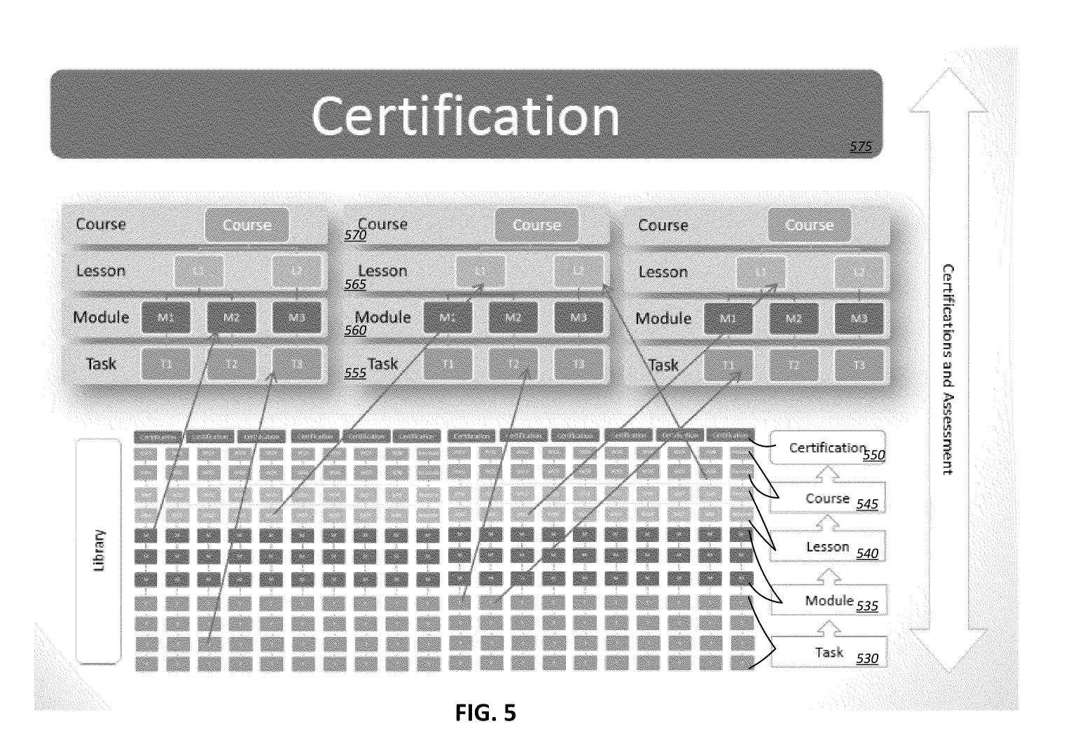

FIG. 5 is a block diagram conceptually illustrating use of an integrated learning system to deliver educational content and services according to one embodiment of the present invention. According to one embodiment, the content objects stored by the storage services 414 described above may each comprise a discrete piece of educational content. For example, the content objects can comprise one or more of documents, videos, audio files, and/or other types of content. As illustrated here, educational elements can be defined using these different content objects 530-550. For example, a set of the content objects 530 can comprise a task 555 within the educational element. These tasks can be combined by other content objects 535 to define a module 560. One or more modules can be assembled by other content objects 540 to form a lesson 565. Further still, one or more lessons can be assembled by other content objects 545 to form a course 570. One or more courses can be assembled by other content objects 550 to form a certification 575 and in some cases including associate, bachelor's etc.

In other words, the integrated learning system 400 described above supports content modularity. Through the content objects of the storage service, task level content can be arranged together into modules, then into lessons, then to courses. This component-driven design using a task-level foundation enables the rapid creation of new training offerings that are applicable to different audiences and different usage scenarios. For example, a single task-level content item might support, 1) targeted, in-field training of technicians via mobile devices in an effort to drive up customer satisfaction, 2) self-study continuing education training in a regulated environment, and/or 3) course material in an academic degree program.

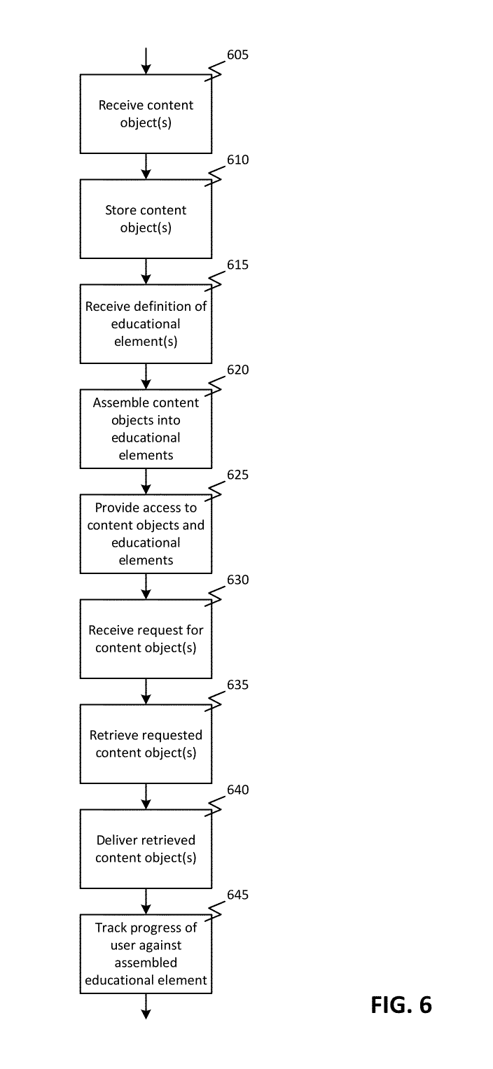

FIG. 6 is a flowchart illustrating a process for delivering educational content and services according to one embodiment of the present invention. As illustrated in this example, delivering educational content and services can begin with receiving 605 and storing 610 content objects or an indication of the content objects from an author of an educational element. Each content object may comprise a discrete piece of educational content. For example, the content objects can comprise one or more of documents, videos, audio files, and/or other types of content. A definition of one or more educational elements can also be received 615, e.g., from the author of the educational element. Each educational element can comprise one or more of the content objects. The one or more of the content objects can be assembled 620 into the educational element based on the received definition. For example, the content objects can comprise a task within the educational element, the educational element can comprise a module, and one or more tasks are assembled to form the module. Further, the educational element can comprise a lesson and one or more modules can be assembled to form the lesson. Further still, the educational element can comprise a course and one or more lessons can be assembled to form the course.

Once the educational element has been defined, access to the content objects and educational elements can be provided 625 to a user. Providing 625 access to the content objects and educational elements to the user can comprise allowing the user to browse the content objects and educational elements. Additionally or alternatively, providing 625 access to the content objects and educational elements to the user can comprise allowing the user to search the content objects and educational elements.

At some point, a request for at least one of the content objects of the educational element can be received 630 from the user and the requested content object can be retrieved 635 and delivered 640 to the user in response to the request. In some cases, retrieving 635 the requested content object and delivering 640 the requested content object can comprise retrieving 635 and delivering 640 a plurality of content objects within a module, lesson, or course. Additionally or alternatively, retrieving 635 the requested content object and delivering 640 the requested content object can comprise retrieving 635 and delivering 640 a plurality of content objects within a module, lesson, or course. Progress of the user can be tracked 645 against the assembled educational element based on delivery of the retrieved content object. For example, tracking 645 progress of the user can comprise determining completion of a task, a module, a lesson, and/or a course.

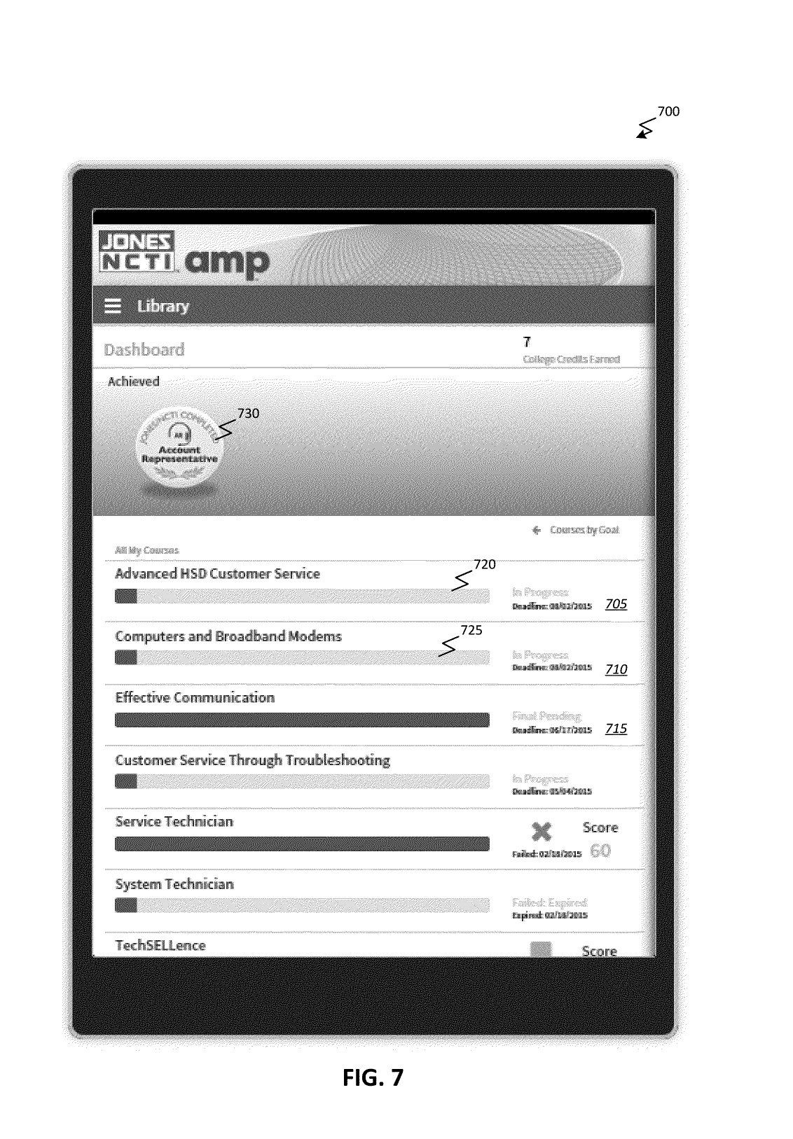

FIG. 7 illustrates an exemplary user interface for representing tracked progress according to one embodiment of the present invention. As noted above, tracking progress of the user can comprise determining completion of a task, a module, a lesson, and/or a course. This tracked progress can be monitored by the user and/or others through the student services, e.g., through a dashboard interface provided by the student services. As illustrated in this example of such an interface 700, a number of graphical, textual, and/or other elements can represent the courses or other educational elements the user is or has been enrolled in and the progress of the user in each. For example, the interface can be divided into a number of regions 705, 710, 715, each representing a particular course, lesson, or module. Each region can include a progress bar 720 and 725 or other graphical, textual, or other representation of the user's progress, e.g., based on tasks, modules, and/or lessons completed within that course or educational element. In some cases, the interface 700 can also include one or more graphical or other representations 730 of completed courses or certifications the user has achieved to date. It should be understood that this exemplary interface is provided for illustrative purposes only and is not intended to limit the scope of the present invention. Rather, the actual format, content, and other features of the interface can vary widely between implementations without departing from the scope of the present invention.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums or memory devices, such as CD-ROMs or other type of optical disks, floppy diskettes, ROMs, RAMs, EPROMs, EEPROMs, magnetic or optical cards, flash memory, or other types of machine-readable mediums or memory devices suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for delivering educational content and services, the method comprising:
storing a plurality of content objects, each content object comprising a discrete piece of educational content;
receiving a definition of one or more educational elements, each educational element comprising one or more of the content objects;
assembling the one or more of the content objects into the educational element based on the received definition;
receiving from a user a request for at least one of the content objects of the educational element;
retrieving the requested content object;
delivering the retrieved content object to the user in response to the request; and
tracking progress of the user against the assembled educational element based on delivery of the retrieved content object.

2. The method of claim 1, wherein the content objects comprise one or more of documents, images, videos, or audio files.

3. The method of claim 1, wherein the content objects comprise a task within the educational element and wherein tracking progress of the user comprises determining completion of the task.

4. The method of claim 3, wherein the educational element comprises a module, wherein one or more tasks are assembled to form the module, and wherein tracking progress of the user comprises determining completion of the module.

5. The method of claim 4, wherein the educational element comprises a lesson, wherein one or more modules are assembled to form the lesson, and wherein tracking progress of the user comprises determining completion of the lesson.

6. The method of claim 5, wherein the educational element comprises a course, wherein one or more lessons are assembled to form the course, and wherein tracking progress of the user comprises determining completion of the course.

7. The method of claim 6, wherein retrieving the requested content object and delivering the requested content object comprises retrieving and delivering a plurality of content objects within a module, lesson, or course.

8. The method of claim 1, further comprising, prior to storing the plurality of content objects, receiving the content objects or an indication of the content objects from an author of the educational element.

9. The method of claim 8, wherein the definition of the one or more educational elements is received from the author of the educational element.

10. The method of claim 1, further comprising, prior to receiving the request for at least one of the content objects, providing access to the content objects and educational elements to the user.

11. The method of claim 10, wherein providing access to the content objects and educational elements to the user comprises allowing the user to browse the content objects and educational elements.

12. The method of claim 10, wherein providing access to the content objects and educational elements to the user comprises allowing the user to search the content objects and educational elements.

13. A system comprising:
a processor; and
a memory coupled with and readable by the processor and storing therein a set of instructions which, when executed by the processor, causes the processor to deliver educational content and services by:
storing a plurality of content objects, each content object comprising a discrete piece of educational content;
receiving a definition of one or more educational elements, each educational element comprising one or more of the content objects;
assembling the one or more of the content objects into the educational element based on the received definition;
receiving from a user a request for at least one of the content objects of the educational element;
retrieving the requested content object;
delivering the retrieved content object to the user in response to the request; and
tracking progress of the user against the assembled educational element based on delivery of the retrieved content object.

14. The system of claim 13, wherein the content objects comprise one or more of documents, images, videos, or audio files.

15. The system of claim 13, wherein the content objects comprise a task within the educational element and wherein tracking progress of the user comprises determining completion of the task.

16. The system of claim 15, wherein the educational element comprises a module, wherein one or more tasks are assembled to form the module, and wherein tracking progress of the user comprises determining completion of the module.

17. The system of claim 16, wherein the educational element comprises a lesson, wherein one or more modules are assembled to form the lesson, and wherein tracking progress of the user comprises determining completion of the lesson.

18. The system of claim 17, wherein the educational element comprises a course, wherein one or more lessons are assembled to form the course, and wherein tracking progress of the user comprises determining completion of the course.

19. The system of claim 18, wherein retrieving the requested content object and delivering the requested content object comprises retrieving and delivering a plurality of content objects within a module, lesson, or course.

20. The system of claim 13, further comprising, prior to storing the plurality of content objects, receiving the content objects or an indication of the content objects from an author of the educational element.

21. The system of claim 20, wherein the definition of the one or more educational elements is received from the author of the educational element.

22. The system of claim 13, further comprising, prior to receiving the request for at least one of the content objects, providing access to the content objects and educational elements to the user.

23. The system of claim 22, wherein providing access to the content objects and educational elements to the user comprises allowing the user to browse the content objects and educational elements.

24. The system of claim 22, wherein providing access to the content objects and educational elements to the user comprises allowing the user to search the content objects and educational elements.
